(19) United States
(12) Patent Application Publication
(10) Pub. No.: US 2015/0170286 A1
(43) Pub. Date: Jun. 18, 2015

(54) METHOD AND SYSTEM FOR FACILITATING AND OPERATING TRANSACTIONS INVOLVING THE FUNDING OF INVESTMENTS IN ENERGY VENTURES OR PROJECTS

(71) Applicants: Roger Burt Gingell, Houston, TX (US); Philip Racusin, Houston, TX (US)

(72) Inventors: Roger Burt Gingell, Houston, TX (US); Philip Racusin, Houston, TX (US)

(73) Assignee: EnergyFunders, LLC, Houston, TX (US)

(21) Appl. No.: 14/572,086

(22) Filed: Dec. 16, 2014

Related U.S. Application Data
(60) Provisional application No. 61/916,776, filed on Dec. 16, 2013.

(51) Int. Cl. G06Q 40/06; G06Q 30/00

(52) U.S. Cl. CPC G06Q 40/06; G06Q 30/018

(57) ABSTRACT

A process for funding an energy venture or project includes providing a project proposal to a platform host, reviewing the project proposal by the platform host to determine if the project proposal meets criteria set by the platform host, placing the project proposal on an on-line web-based platform, said platform being accessible by potential investors, accessing the platform by the potential investor so as to allow the potential investors to invest in the project of the project proposal, and funding the project with the investment by the investors. The funding goal includes a time period for funding and an amount of funding.

### CROSS-REFERENCE TO RELATED APPLICATIONS

The patent application claims priority from Provisional Patent Application Ser. No. 61/916,776, filed on Dec. 16, 2013, and entitled “Method and System for Facilitating and Operating Transactions Involving the Funding of Investments in the Production or Acquisition of Hydrocarbons, or Revenue Stream Generated Thereby”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to crowdfunding processes. More particular, the present invention relates to the crowdfunding of hydrocarbon ventures. More particular, the present invention relates to processes whereby hydrocarbon ventures can be funded by way of a web-based platform.

2. Description of Related Art Including Information Disclosed Under 37 CFR 1.97 and 37 CFR 1.98

Historically, oil and gas drilling deals and deals to purchase passive investment interests, such as royalty and non-operated working interests, have been reserved only for well-connected players in the oil and gas industry with the right connections and large sums of money to invest. These players know how to navigate complex agreements, such as joint operating agreements and farm-outs. As such, the industry has largely been closed to the common investor that seeks outsized returns along with the willingness to take the risk of a dry hole and other exploration and production risks.

From a historical perspective, the small independent oil and gas company or a geologist with an idea, commonly known as a “wildcatter”, have been reliant on venture capital firms, investment banks, wealthy individuals and partnerships have large oil companies in order to raise the funds to drill their wells. These funds often came with undesirable terms attached thereto. The history of the oil and gas industry in the United States is written with tales of wildcatters who cannot obtain the financing that is needed at critical times. Even legendary wildcatters have not been immune to this common problem. This problem certainly persists to the present.

The oil and gas industry has historically used boilerplate language and contract forms to make it easy to incorporate new investors into the projects. For the last century, the domestic exploration and production industry was built upon allowing new investors to take a risk in drilling wells. It also allows for the financing of the small operator. Small operators still account for the majority of production in the United States.

The most common investment vehicle for oil and gas drilling projects has been the Joint Operating Agreement. The Joint Operating Agreement is an industry form that has been updated and modified numerous times. The Joint Operating Agreement dates back to at least the 1940's. The Joint Operating Agreement essentially governs the relationship between working interest owners in an oil and gas well and defines the duties of the operator of the well in relation to the non-operating working interest owners of the well.

Unfortunately, capital infusions into the industry remain limited by the general lack of expertise outside of the “land business” in the navigation of oil and gas contracts. This has contributed to a close-knit nature of the industry. It has also contributed to the lack of deals offered to investors that have full transparency and has also led to the proliferation of fraudulent oil and gas investment opportunities offered by those willing to take advantage of the lack of opportunities to invest.

It has been estimated that currently over $10 billion per year of equity crowdfunding transactions have been taking place. However, there has been no medium provided to finance oil and gas exploration and production which utilizes crowd-funding. Crowdfunding would address many of the historical problems associated with oil and gas financing.

The traditional technique for the funding of oil and gas projects is the establishment of a project proposal. Once a project proposal is established, due diligence is carried out by the financiers or investors on the project. This due diligence can consist of a thorough investigations of various attributes, such as investigations of the titles associated with the project, investigating the background and history of the operator, along with a thorough review of the project proposal and an analysis of engineering and economic perspectives. After the due diligence has been completed, the funding by the large investment operation can occur. Once the funding is available, a Purchase & Sale Agreement is entered into between the financiers and the operator. The Purchase & Sale Agreement will provide details of how the money from the project will flow back to the investor and the process by which the investor can profit from the investment. Once the Purchase & Sale Agreement has been executed by the relevant parties, the funding is provided to the operator so as to allow for the drilling of the well. The well is owned by the operating and non-operating working interest owners.

Crowd-sourced funding, otherwise known as “crowdfunding” is a concept whereby groups of people, or a “crowd”, collectively pool their funds for one goal. Presently, various crowdfunding opportunities have been made available for those persons with inventions or business concepts. Typically, a person that seeks crowdfunding will put a project proposal on certain websites. Unfortunately, there is almost no due diligence that occurs before the investment is made. As such, investors are likely to lose their investments based upon a lack of information or fraudulent information. Typically, the platform host for such crowdfunding websites will receive a portion of the investment prior to the investment being delivered to the company or person with the particular project. As such, the person or company with the particular project will receive only a portion of the investment. As a result, the return to the investor will also be reduced by the amount of money that has been taken out by the platform host. Additionally, and furthermore, the platform host usually takes no responsibility for, or risk associated, with the success of that particular opportunity. As a result, current crowdfunding operations have been unsuitable for the use in funding of hydrocarbon ventures. Quite clearly, traditional crowdfunding (non-equity crowdfunding or donative crowdfunding) would fail to satisfy the requirements of the Securities Act.

In the past, a variety of patents have issued with respect to crowdfunding. For example, U.S. Pat. No. 5,663,547, issued on Sep. 2, 1997 to W. A. Ziarno, shows a method of fund-raising with a keyless contribution and gift commitment management device. This method involves dispersing through a crowd of prospective contributors or gift givers a plurality of keyless electronic contributions or gift management devices for immediate entry of consecutive data including the identities of contributors making the monetary contribution commitments. The method further includes the step of supplanting a gift recipient or fund-raising organization with another gift recipient or fund-raising organization to which the contribution or gift commitments are made. The data for a plurality of contributions or gift commitments is communicated in a substantially continuous stream to a remote device for immediate recordation thereon on the remote device.

U.S. Pat. No. 6,920,495, issued on Jul. 19, 2005 to Fuselier et al., shows a method for facilitating web-based information exchange. This method includes providing a centralized web structure for the information pertaining to an organization. The web-based information includes webpages and interactive web-based applications. The web structure includes multiple websites linked to at least one common site to which the web-based information generated by the organization is linked. The web structure provides a user with a single point of entry access to the web-based information of the organization.

U.S. Pat. No. 7,548,880, issued on Jun. 16, 2009 to H. P. Mintz, shows a method of operating a venture capital investment business. This method includes establishing a business entity, establishing an investment fund, and establishing a fund management entity of the investment fund. The fund managing entity attends to the administrative matters relating to the investment fund and makes investment decisions for the fund. The investment fund has investors that provide capital contributions to the fund. The fund managing entity also provides capital contributions to the fund. The fund utilizes the contributions to invest in portfolio entities. The investors receive a general participation interest in the fund. The fund managing entity receives a carried interest in the fund. The investors are provided with stock rights in the business entity to enable the investors to become shareholders in the business entity.

U.S. Pat. No. 7,651,395, issued on Jan. 26, 2010 to A. S. Van Luchene, provides video game methods and systems for obtaining funding for developing game environments. The method includes a variety of funding sources so as to transform the game environment into a public company through an initial public offering or through a follow-on offering such as the issuance of common stock. The method allows members of the venture capital entity to vote on whether or not to fund a given venture.

U.S. Pat. No. 7,761,376, issued on Jul. 20, 2010 to Cudzilo et al., discloses a method for providing funding and access to an investment vehicle. This method includes the steps of establishing an investment vehicle, monetizing the investment vehicle by depositing funds therein by at least one predetermined investor, receiving a request for the funds by an employee of an employer, distributing the funds from the investment vehicle to a financial institution via a management entity upon direction of the management entity in response to the employees's request, transferring the funds from the financial institution to the employee via the employer, utilizing the funds for a predetermined economic activity by the employee, remitting the funds to the financial institution from an employee's subsequent earnings via an employer payroll system, and re-depositing the funds into the investment vehicle via the management entity.

U.S. Pat. No. 7,809,641, issued on Oct. 5, 2010 to Sanders et al., shows a system and method for funding a collective account. This method includes issuing a plurality of financial instruments, linking the financial instruments to the collective account, aggregating individual financial instrument usage, calculating a bonus or other reward based on the aggregate financial instrument usage and funding or distributing the reward to the collective account.

U.S. Pat. No. 7,827,081, issued on Nov. 2, 2010 to Sinha et al., provides a business facilitation system that enables retail investors to acquire equity in business entities that are seeking equity financing. The fund seeker electronically posts a proposal seeking funds. Investors commit to buying the private equity at a rate fixed through electronic communication. If the funds sought are not met by unconditional commitments, then the investors who had indicated interest can make conditional commitments based on the results of due diligence for which they are willing to pool in funds. If a certain percentage of the funds sought to be committed or met through conditional commitments whose conditions are satisfied within a fixed time period, then the fund seeker honors the proposal.

U.S. Pat. No. 7,849,003, issued on Dec. 7, 2010 to Ignatios et al., discloses methods and systems for monitoring an online account opening service. The system includes an account management system that performs an online account opening service and includes a management console application. The online account opening service electronically receives account application information and funding information specifying at least one funding source, processes the account application to access a risk to a financial institution of opening an account for a customer, processing the funding source information to assess a risk to the financial institution of transferring funds from the funding source to the account, and electronically transferring funds from the funding source to the account based on the risk to the financial institution of opening the account for the customer and the risk to the financial institution of transferring funds from the funding source to the account.

U.S. Pat. No. 7,933,825, issued on Apr. 26, 2011 to H. P. Mintz, discloses a method of operating a venture business. This method includes establishing a business entity, establishing an investment fund, and establishing a fund managing entity of the investment fund. The fund managing entity attends to administrative matters relating to the investment fund and makes investment decisions for the fund. The investment fund has investors that provide capital contributions to the fund. The fund managing entity also provides capital contributions to the fund. The fund utilizes the contributions to invest in portfolio entities. The investors receive a general participation interest in the fund. The fund managing entity receives a carried interest in the fund. The investors are provided with stock rights in the business entity to enable the investors to become shareholders in the business entity.

U.S. Pat. No. 7,945,514, issued on May 17, 2011 to Sanders et al., shows a system and method for funding a collective account, such as a charitable account. This method includes issuing a plurality of financial instruments, linking the financial instruments to the collective account, aggregating individual financial instrument usage, calculating a bonus or other reward based on the aggregate financial instrument usage, and funding or distributing the reward to the collective amount.

U.S. Pat. No. 8,036,985, issued on Oct. 11, 2011 to Reid et al., discloses a method for pre-funding. The method includes sending a plurality of pre-fund authorization requests to a buyer financial institution, and then receiving a plurality of responses to the pre-fund authorization requests from the buyer financial institution. Each request either accepts or declines a pre-fund authorization request. A fund transfer request is sent to the buyer financial institution. The fund transfer request corresponds to a total value of the accepted pre-fund authorization requests.

U.S. Pat. No. 8,156,031, issued on Apr. 10, 2012 to H. P. Mintz, teaches a method of operating a venture capital business. This method includes establishing a business entity, establishing an investment fund, and establishing a fund managing entity of the investment fund. The fund managing entity attends to administrative matters relating to the investment fund and makes investment decisions for the fund. The investment fund has investors that provide capital contributions to the fund. The fund managing entity also provides capital contributions to the fund. The fund utilizes the contributions to invest in portfolio entities. The investors receive a general participation interest in the fund.

U.S. Pat. No. 8,214,284, issued on Jul. 3, 2012 to Selious et al., shows a method for managing funding of catastrophic relief efforts. A monetary donation is made to the charitable organization for paying a premium assigned to the financial product. Capital payments are received from one or more investors for the financial product. The premium is paid by the special purpose entity to the investors. Upon the occurrence of a catastrophic event assigned to the financial product, the capital is paid from the special purpose entity to the charitable organization for funding relief efforts for the catastrophic event. Otherwise, the capital is repaid from the special purpose entity to the investors.

U.S. Pat. No. 8,221,242, issued on Jul. 17, 2012 to A. Van Luchene, discloses products and processes that permit a player to obtain funding for developing game environments. The funding sources are provided that transform the game environment into a public company through an initial public offering or through a follow-on offering, such as the issuance of common stock, preferred stock, and treasury stock.

U.S. Pat. No. 8,285,624, issued on Oct. 9, 2012 to Kuhnle et al., shows a method for managing redemptions. The method includes receiving a request to redeem shares of a fund for a given market participant, communicating before a strike time an identification of a set of assets to distribute to the given market participant representative, calculating a true-up amount based on a monetary value at the strike time of the set of assets and either the monetary value as of the strike time of the number of shares requested to be redeemed, and causing a transfer of all or a portion of the set of assets to the market participant representative.

U.S. Pat. No. 8,447,682, issued a May 21, 2013 to H. P. Mintz, discloses a method of operating a venture capital investment business. This method includes establishing a business entity that establishes an investment fund and a fund managing entity that tends to administrative matters relating thereto and makes investment decisions for the fund. The investment fund has investors that provide capital contributions to the fund that the fund utilizes to invest in portfolio entities. The investors receive a general participation interest in the fund. The fund managing entity receives a carried interest in the fund. Investors provide at least a threshold capital contribution to the fund with stock rights in the business entity to enable such investors to become shareholders in the business entity. The business entity secures a portion of the IPO shares that become available in the portfolio entities. The business entity enables shareholders thereof to purchase IPO shares that become available in the portfolio entities.

It is an object of the present invention to provide a process that facilitates the investors' pooled investment in exchange for a beneficial right, or right conveyed by ownership of an investment entity, to receive revenue.

It is another object of the present invention to provide a process that allows operators to secure funding.

It is another object of the present invention provide a process that allows investors to invest in multiple projects.

It is another object of the present invention to provide a process whereby investors can invest with low buy-ins.

It is another object of the present invention provide a process that provides funding in an expedited time frame.

It is still a further object of the present invention to provide a process that allows working interest owners to receive a carried interest in the venture and on revenue generated by the hydrocarbon venture.

It is another object of the present invention to provide a process that facilitates transactions, commitments, and payment.

It is another object of the present invention to provide a process that enhances information available to the investor.

It is still a further object of the present invention to provide a process that is compliant with the Safe Harbor provisions of the Securities Act.

It is still another object of the present invention to provide a process that protects against out-of-pocket expenses after the purchase price has been paid.

It is still another object of the present invention provide a process that allows the operator to have an option of when to be paid.

It is a further object of the present invention to provide a process that avoids transaction fees.

These and other objects and advantages of the present invention will become apparent from a reading of the attached specification and appended claims.

### BRIEF SUMMARY OF THE INVENTION

The present invention is a process for funding an energy venture or project. The process includes the steps of: (1) providing a project proposal to a platform host; (2) reviewing the project proposal by the platform host to determine if the project proposal meets criteria set by the platform host; (3) placing the project proposal on an on-line web-based platform in which the platform is accessible by potential investors; (4) accessing the platform by the potential investors so as to allow the potential investors to invest in the project of the project proposal; and (5) funding the project with the investment by the investors. As used herein, the platform host can include entities that are contracted with the platform host and entities owned by or under the control of the platform host.

In the process of the present invention, a funding goal is established for the project. The step of funding occurs only if the funding goal is reached. The funding goal can include a time period for funding and an amount of funding. The step of reviewing includes conducting due diligence by the platform host and developing a Purchase & Sale Agreement between the platform host and an operator associated with the project proposal. A working interest in the project is conveyed to the platform host after the step of funding. The revenue from the project is conveyed to the investors relative to an amount invested by the investors. In particular, the conveying includes conveying the revenue from the project to the platform host and then conveying revenue from the platform host to the investors. The potential investor is accredited by the platform host in order to cause the potential investor to become the actual investor. The investment is returned to the investor if the funding goal is not reached.

This foregoing Section is intended to describe, with particularity, the preferred embodiment of the present invention. It is understood that modifications to this preferred embodiment can be made within the scope of the present invention. As such, this Section should not to be construed, in any way, as limiting of the broad scope of the present invention. The present invention should only be limited by the following claims and their legal equivalents.

### BRIEF DESCRIPTION OF THE DRAWINGS

FIGS. 1-1C comprise a flow diagram showing the steps of the process of the present invention.

### DETAILED DESCRIPTION OF THE INVENTION

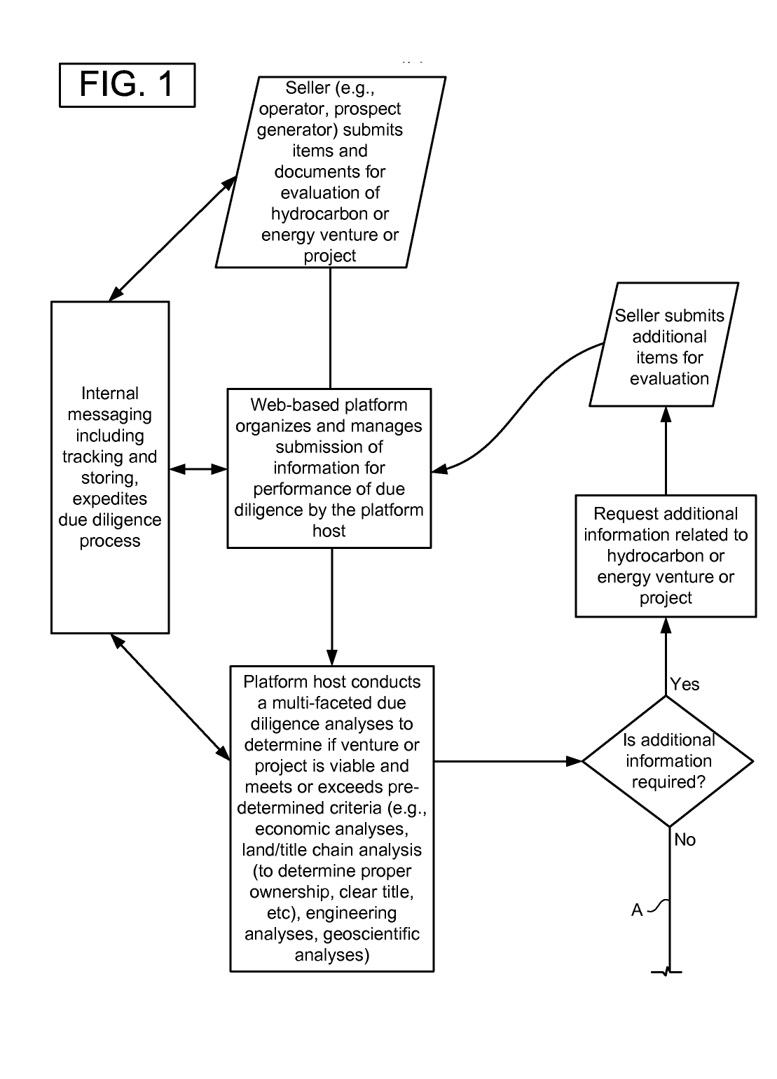

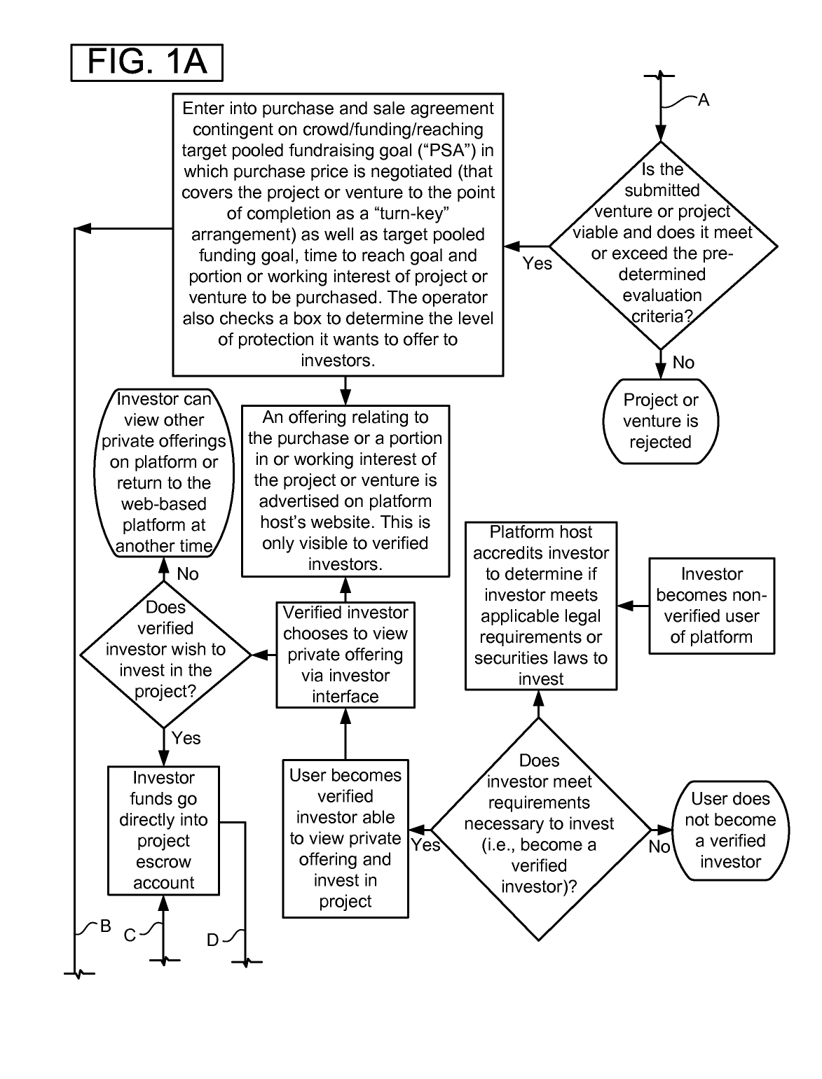

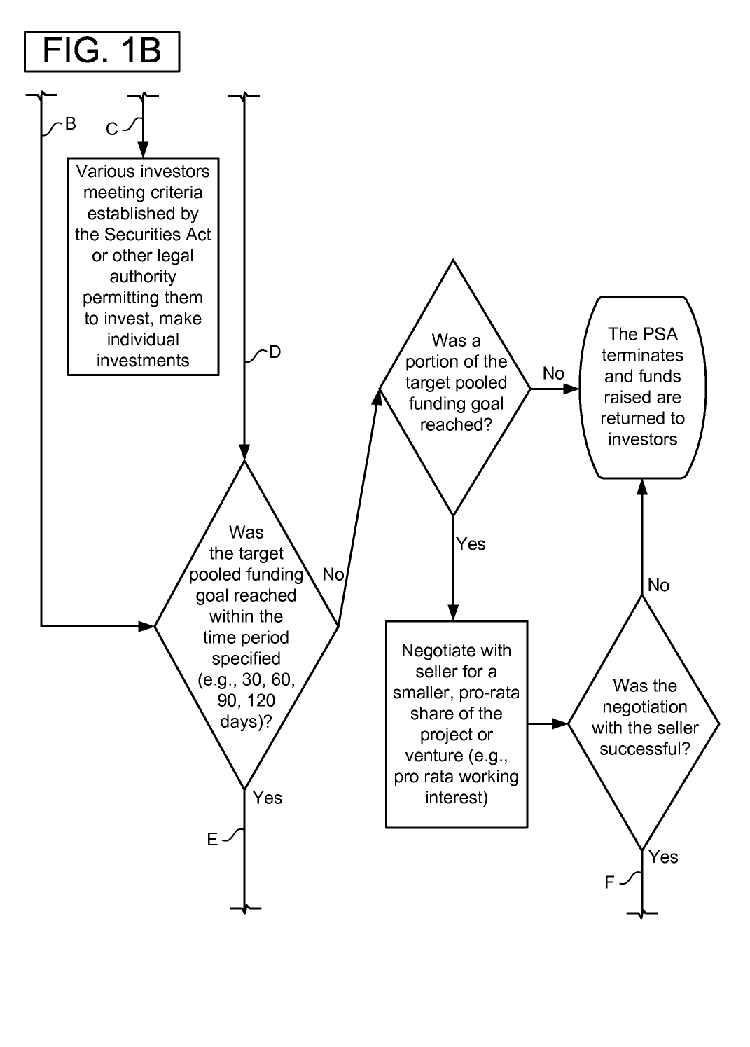

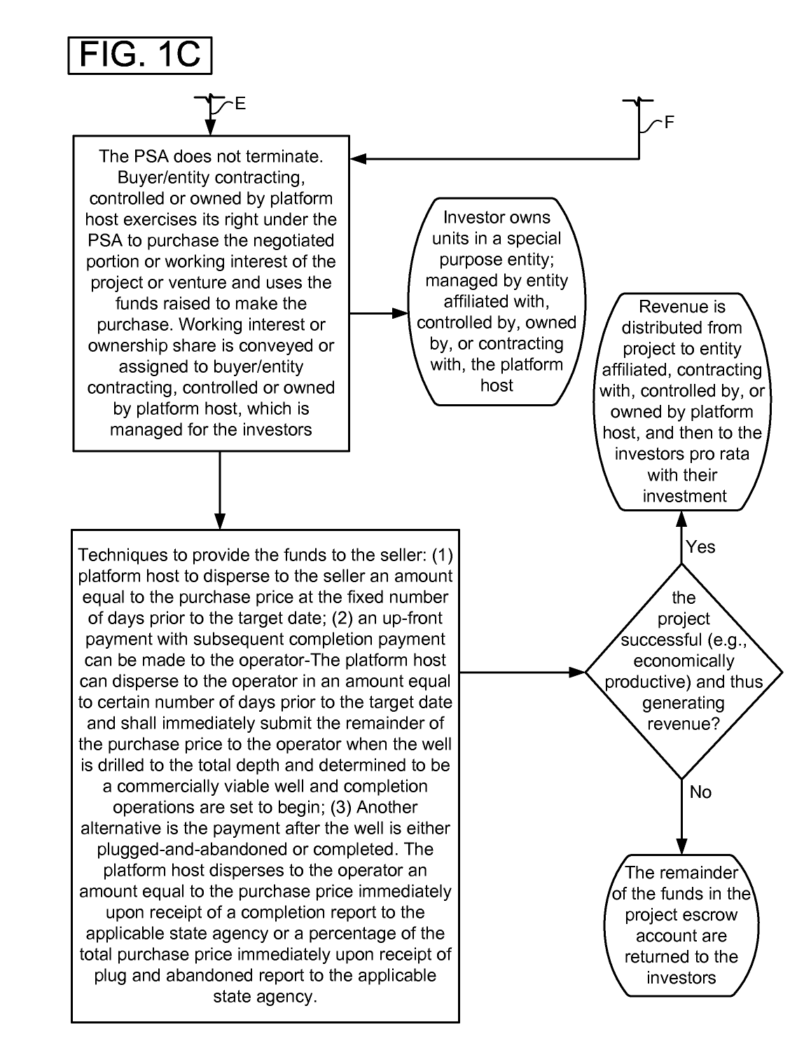

Referring to FIG. 1A-1C, the present invention is a process for funding an energy venture or project. In particular, this process includes the providing of a project proposal to a platform host. The project proposal is reviewed by the platform host for due diligence in order to determine if the project proposal meets criteria set by the platform host. Once the project meets the criteria set by the platform host, the project proposal, or actual project, is placed on an on-line web-based platform. This platform is accessible by potential investors. The potential investors will access the platform so as to allow the potential investors to invest in the project associated with the project proposal. Ultimately, the money provided by the investors through the platform will allow for the funding of the project.

In the present invention, a funding goal is established for the project. The actual funding of the project will only occur if the funding goal is reached. If the funding goal is not reached, then the monies that are committed by the various investors are returned to the investors, or otherwise carried over, at the choice of the investor, to another project. The funding goal will include a time period for funding, such as 30 days, 60 days, 90 days or 120 days. Additionally, the funding goal also includes an amount of funding. The amount of funding can vary widely, depending upon the amount of money sought for the particular project.

Due diligence is carried out by the platform host on the project proposal. Typically, the due diligence will occur prior to the step of establishing the Purchase & Sale Agreement. During the course of due diligence, the background and history of the operator is reviewed by the platform host. Additionally, the details of the project proposal also reviewed by the platform host including from a feasability, economic and/or engineering (and geoscience) perspective. Furthermore, to the extent that land associated with the project and/or mineral rights are involved with the project, the various titles associated with the project are also reviewed by the platform host. In all circumstances, the term “platform host”, as used herein, refers to the actual platform host, those under the control of the platform host, those owned by the platform host, and those in a contractual relationship with the platform host. Ultimately, after the due diligence has been completed, the Purchase & Sale Agreement is developed between the platform host and an operator associated with the project proposal. This Purchase & Sale Agreement can then be executed by the various parties so that the parameters of the deal are established.

Within the process of the present invention, a working interest in the project is conveyed to the platform host after the step of funding. Since the platform host owns the working interest, the revenue generated by the operator can be conveyed to the platform host in a proportion corresponding to the working interests. The platform host can then convey the revenue from the project to the various investors in an amount relative to an amount invested by the investors.

The potential investor is accredited by the platform host. As such, the various investors will have to meet the criteria established by the Securities Act in order to invest in the energy venture or project. Each potential investor must complete information, as will be described hereinafter, so as to allow the platform host to ascertain whether they qualify under the Securities Act and can become actual investors.

The web-based platform can also be utilized by the operator so as to convey necessary information so as to carry out the due diligence by the platform host. The platform will include an operator interface form. This operator interface form can request information from the operator such as company name, contact name, email, phone, company description, management team information, states where the company does business, annual revenue, a typical product or project description, identifying details of prior successful project(s), and the details associated with the project. In particular, the operator must submit information pertaining to the project, such as the name of the project, the percentage of the working interest that is available, the total investment that is required, the minimum investment required, the location of the drilling, well(s) or project site, along with terms and conditions. Once the operator submits information, the platform host will inform the operator that the due diligence team will review the application and will report back to the operator. If the information submitted by the operator is insufficient, the platform host will inform the operator that the information is not sufficient in order to approve membership at this time. If the operator application has been approved, the platform host will inform the operator that they have been approved. If the information that is provided by the operator on the operator interface form of the platform is insufficient, then the platform host can request further information from the operator, such as requiring further seismic data or other information pertaining to the specific location and/or attributes of the drilling, the well(s), project site or the venture or project itself. Once the project has been approved, the project will appear on the Operator Dashboard of the platform. As investment is received, continual information will be provided to the operator as to the amount of money that has been raised and the number of days remaining until the deadline. Ultimately, as the deadline approaches, further notifications are provided by the platform host to the operator until the project funding deadline. Further information will be provided to the operator if it appears that it is unlikely that the funding goal will be realized before the deadline. Once the full funding has been achieved, a notification will be sent by the platform host to the operator informing them of such. As a result, project disclosure requirements under the terms and conditions mutually agreed upon at the time of submission will now be in effect.

The platform will further include a user interface form. As such, as potential investors access the platform, the investor can become involved by completing the user interface form. The user interface form will request typical information such as first name, last name, email, password, along with confirmation of the password. An investor questionnaire is provided pertaining to the name of the investor, the type of owner or form of the ownership, the address, telephone number, fax number, email, etc. In particular, with respect to the particular type of investor, a designation should be made as to whether the investor is an individual, a partnership, a corporation, a trust, a limited liability company, tenants in common, joint tenants with right of survivorship, an employee benefit plan, and IRA, a Keogh Plan, or other type of plan. By providing this information, the potential investor can set up an account. Ultimately, after the information is received, the platform host will process the information and inform the invest potential investor as to whether they are approved or not approved. If the potential investor is approved and becomes an actual investor, then details as to the various projects available for investment can be provided to the investor including, by way of an investor dashboard and on the project page for each particular project available for investment. The investor is informed as to the number of days remaining and amount of funds sought that are still available for investment in order to invest in a particular project. Ultimately, if the funding goal of a particular project has not yet been reached, further notifications can be sent to the investor to inform them that happened and that an opportunity is available to invest in another particular project. Once the project is actually funded, then a notification will be provided by the platform host to the investor as to periodic updates on the progress of the project. If the project is not fully funded, then the investor will be informed of the inability to achieve the funding goal. The platform host can then return the investment, in one form or another, to the investor.

It is important in the process of the present invention that only accredited investors, or investors able to invest that are in legal compliance with applicable federal or state security laws, are involved with the platform. As such, the investor will have to identify whether they are accredited investor, an entity that is able to invest, or an entity that is able to invest in legal compliance with the applicable federal or state security laws, or as an international investor that is able to invest in legal compliance with applicable securities laws. The various inquiries on the platform with respect to whether the investor is “an accredited investor”, or a domestic or international investor in legal compliance with applicable securities laws, in compliance with the requirements of the Securities Act. The platform has traditional customary advisory roles involved in vetting investments and for performing due diligence, as an added value to investors.

The platform is facilitated through a website having an integrated system of sophisticated back-end software coupled with sophisticated front-end software. The platform will host and facilitate only certain types of deals. These deals can include financing deals with the operator for a proposed single wellbore or for a proposed drilling plan for wells to be drilled continuously in one area, the operator or owner for a well or wells to be reworked or otherwise stimulated to restart or increase production of hydrocarbons, a plan to finance a renewable energy project, such as wind, solar, hydropower or geothermal, the owner for an acquisition of some or all of its revenue stream flowing from a producing well, a unit of wells, or a package of wells (i.e., a royalty), or the owner for an acquisition of some or all of its non-operating working interest in a producing well. The working interest is a form of investment in oil and gas drilling operations in which the investor is directly liable for a portion of the ongoing costs associated with exploration, drilling and production and also fully participates in the profits of any successful wells. Only ready-to-go permitted wells with all land and other due diligence completed will be allowed to be offered on the platform.

Within the concept of the present invention, the platform can allow investors the ability to purchase working interests from a non-operator in proposed wells and also include the ability to purchase into royalty packages which offer less risk and much lower returns (which require much higher levels of due diligence manpower than drilling a single well or a small drilling program). In turn, non-operators can sell their non-operating working interest in proposed wells. Any investor owning one or more royalties can sell them to investors by way of the platform.

Oil and gas operators that are interested in obtaining financing must submit to the platform host a general overview of their plan to drill rework, or stimulate an existing permitted or to-be-permitted well or wells in the same manner as they would be required to any potential non-operating working interest owner. They must also submit requested economic documents, scientific analysis documents, land-related due diligence materials, including a title opinion or other documents evidencing or showing a sufficient chain of title, and a Joint Operating Agreement or proposed Joint Operating Agreement. The operators must also provide due diligence materials regarding the authority for expenditures for each well. These materials would comprise the totality of all typical industry documentation that a potential non-operating working interest owner would demand in order to conduct industry-standard due diligence in this context. An operator that submits the due diligence package must submit anything that is required to prove clear title to a drill or project site. In particular, this can include leases, title opinions, and other documents that are needed to clear a drilling rig or other equipment in order to begin drilling, re-working, or stimulation from the legal and land perspective. When an operator fails to submit clear title for drilling, supplemental materials may be requested. If the supplemental materials are not provided, the proposal will be rejected. Additionally, the operator must provide a drilling, re-working, or stimulation strategy that includes a drilling, re-working, or stimulation cost budget, along with geological and due diligence material. The geological material can include the geology of the area and nearby existing production. The project's due diligence package is posted for review to the various potential investors to allow for a uniform information format and full transparency in the funding process. This level of transparency is a major benefit provided to the crowd-funding process of the present invention.

After the due diligence is completed, the platform host and the operator will begin the process of entering into a Purchase & Sale Agreement that is contingent upon fully crowd-funding the purchase price. In this regard, the operator must assign a value to the working interest to be conveyed to the platform host upon successful completion must specify the amount of time that the platform host has exclusive rights to raise revenue in order to meet the purchase price. The specified amount of time may commonly be 30, 60, 90 or 120 days.

The due diligence vetting includes a review of the operator and a review of the proposed drilling pad plan, or plan to rework or stimulate the well, as applicable. The review further includes the due diligence package. The title to the drill, rework, or stimulation is also reviewed. Importantly, the platform host will provide a pre-determined format of the land due diligence so as to reduce the process to a checklist form. Through the use of the platform and the specified format on the platform, the potential hydrocarbon venture can be easily reviewed by an expert in the field. The land due diligence is still reviewed by a qualified land man having experience in clearing title for drill or other sites.

The process of the present invention provides the crowdfunding of the hydrocarbon or energy venture or project. If the purchase price is not reached within the specified time, all money contributed by each investor to the project is returned. This concept will protect the investor from investing in a project that is underfunded and protects the operator from having the responsibility to proceed with a project that is underfunded or lacks sufficient funds for success. The funds are held in escrow until such time as the funding goal is reached. If the funding goal is not reached, it is returned in full to each investor, or the investor may elect to have the funds transferred to another venture or project.

Upon approval of a project for placement on the platform, the Purchase & Sale Agreement is entered into between the platform host and the operator. The Purchase & Sale Agreement contains some usual and customary features. It also includes one or more critically distinguishing features. This feature is that it terminates if the purchase price is not raised within the specified time frame. It also contains protection against out-of-pocket expenses for the purchaser as working interest owner. If the purchase price is not fully raised, investors will immediately have their investment returned to them, or they can elect to have the funds transferred to another venture or project. Banks sometime charge a transaction fee for e-commerce. This fee can be passed to the investors, as long as it is fully disclosed prior to the investment.

The Purchase & Sale Agreement sets the amount of working interest in the hydrocarbon venture or project in the well(s) to be drilled, re-worked or stimulated. The Purchase & Sale Agreement includes the following criteria: (a) the Purchase & Sale Agreement terminates if the purchase price is not raised in a number of days to be agreed upon between the operator of the hydrocarbon venture and the platform host; (b) protection from out-of-pocket expenses after the purchase price is paid with the exception of re-working operation; (c) the operator has the option of when to be paid (e.g. before the well is drilled or after the well is drilled and completed); (d) assignment of the working interest at completion; (e) no transaction fees except third-party fees disclosed ahead of time (e.g. escrow fees); (f) a third-party trustee at the bank (or escrow agent) disperses the funds according to the terms of the Purchase & Sale Agreement; (g) a single working interest block is managed by the platform host and is nontransferable; (h) the platform host may sell the working interest block when the well becomes marginal; (i) the platform host is paid a set percentage (e.g. a carried interest) based on profits generated by the hydrocarbon venture; and (j) the platform host is record title owner of working interest investments and beneficial ownership of working interest (e.g. economic interest via the right to revenue).

The entire drilling proposal, including the due diligence materials, will be posted for review to a “verified investors only” portion of the website. This portion includes accredited investors, other investors able to invest under applicable law, qualified international investors, and potential investors qualified by the Jumpstart Our Business Startups Act.

If the Purchase Price is successfully raised and the well is successfully completed, the operator will use the Purchase & Sale Agreement, by way of the assignment clause therein, so as to assign to the platform host the agreed-upon working interest in the well(s), venture or project. This can range from a small percentage to upwards of 70% or 80%. Every investor is entitled the profits corresponding with his or her pro-rota share of the total purchase price multiplied by 0.90. As such, platform host has a 10% stake in the proceeds as compensation for putting the deal together. This can take the form of a carried interest. The platform host will also manage the land contracts and manage payments to investors from each segregated account associated with each individual project. Ownership can be non-transferable, except by court order, in order to keep overhead costs as low as possible.

When the platform host determines that a well is marginal (e.g. the profit received from the entire production barely exceeds the cost to make the production from the well), the platform host may offer it for sale on behalf of the investors in an arm's length transaction by using a competitive auction process. These competitive auction processes have been offered by other firms now in operation.

Importantly, in the present invention, the platform host does not charge a fee to the investors seeking to invest in a project or venture. The only exception would be if the fee to the investors covers third-party services and is clearly previously disclosed to investors. The revenue to the platform host is only derived from the carried interest in the working interest of any wells that it finances. In other words, the platform host only generates revenue for itself when a well is successful.

When investors sign on to purchase an investment stake in a working interest block in a well or wells in a continuous drilling program, re-work, or well stimulation program offered for sale or in order to invest in the acquisition of a working interest block in an existing well or royalty interest, they will electronically deposit the money into a segregated account and will electronically sign an investor agreement that gives them the right to profit from their pro-rota share of the profits, if any, in a commercial well, less the percentage that is owed to the platform host as a carried compensation for putting the deal together.

The terms of the Purchase & Sale Agreement must carefully balance the protection needs of the investor with the funding needs of the operator. So as to resolve this potential conflict, the operator will have to make certain decisions as to how to offer its working interest for sale in the Purchase & Sale Agreement. The full disclosure is made through the platform to the investors with respect to various items, such as timing of payment and non-consent penalties. With respect to the timing of payment, the highest level of investor protection occurs when payment under the Purchase & Sale Agreement is only made after well(s) is completed or re-worked for commercial production or it is plugged and abandoned as a non-commercially producing dry hole and an independent audit is conducted. The platform host is additionally provided with a completion report for a plug and abandon report (as is known in the oil and gas industry) that is filed with the state that has geographic jurisdiction. The second-highest level of investor protection occurs when a payment is made after a completion. However, operators that need up-front cash in order to drill may not be able to agree to these terms. As such, the money must be paid up-front with the investors bearing the risk of drilling difficulties or operator mismanagement. In this case, the operator must choose between the two payment timing options depending on their particular preference. This election is disclosed to the investors.

With respect to the non-consent penalty, the operator is encouraged to sign a new Wellbore Only Joint Operating Agreement with its other working interest owners, if any, or an agreed to a Purchase & Sale Agreement with the platform host that contains a joint operating agreement with a low non-consent penalty. A non-consent penalty is a penalty incurred by working interest owner who does not consent to bear his proportionate share of the cost of the drilling and operation of the well. Therefore, his interest is picked up by others under the Joint Operating Agreement that will elect to participate with their proportionate share of the non-consent acreage until the share of the expenses is more than repaid. If the operator would not wish to do this, this could be an impediment to the completion of the deal. The operator must disclose up-front any non-consent penalties that can apply to future re-working of the well. This is disclosed to the platform to the investors. The agreement between the platform host and the investors allows the investors to participate in future re-working operations if the funds can be raised in the time frame defined in the Joint Operating Agreement.

The investor receives a significant return on investment if the well is successful. Specific projects will have return estimates provided by the operator. This number is based on the hypothetical reserve volume. This is true if the operator's geologist puts forth a geological theory that is confirmed by the actual drilling of the well. Prior to drilling a well, geologists and engineers try to determine the amount of oil and/or gas that can be produced from the well and use price forecast to determine the value of the product in relation to what it will cost operate the well. As such, a return-on-investment forecast can be made based upon these calculations.

It should be noted that while the projected rate of returns can be very high, the risk is much higher as well. As such, investors will need to be aware that dry holes are inevitable in the business. This is the major reason why oil and gas companies diversify their drilling operations and spread risk across many wells in different assets. As such, the investors utilizing the platform of the present invention are encouraged to do the same.

Ultimately, when the funding goal is realized, there are various techniques to provide the funds to the operator. One of the available options is for the platform host to disperse to the seller an amount equal to the purchase price at the fixed number of days prior to the target date. Alternatively, an up-front payment with subsequent completion payment can be made to the operator. The platform host can disperse to the operator in an amount equal to a certain percentage of the purchase price a certain number of days prior to the target date and shall immediately submit the remainder of the purchase price to the operator when the well is drilled to the total depth and determined to be a commercially viable well and completion operations are set to begin. Another alternative is the payment after the well is either plugged-and-abandoned or completed. The platform host disperses to the operator an amount equal to the purchase price immediately upon receipt of a completion report to the applicable state agency or a percentage of the total purchase price immediately upon receipt of “Plug and Abandoned Report” to the applicable state agency.

The process of the present invention is an online crowd-funding platform that facilitates oil and gas investments by using a Purchase & Sale Agreement that is contingent on the crowdfunding as well as other applications of the existing oil and gas contracts that are tailored specifically to the crowd-funding finance model. The Purchase & Sale Agreement contingent on crowdfunding can be customized to accommodate single well drilling deals, multi-well drilling deals, re-work deals, well stimulation deals, along with the purchase of royalty or non-operated working interest packages. Purchase & Sale Agreements historically have been used and are an agreement to purchase oil and gas interests and then allow a pre-stated time period for the buyer to vet contracts and operations of the seller. The present invention is unique because the vetting has already been carried out prior to the execution of the Purchase & Sale Agreement. The time period that elapses between the signing of the Purchase & Sale Agreement and the execution of the deal is a time period that is used to actually raise the funds needed to execute the deal.

If sufficient funds are not raised to meet the purchase price, the investment and the investor money is immediately returned. If funds are raised, then the Purchase & Sale Agreement remains active and the deal moves forward. This is a completely unique concept in the oil and gas financing world. It is additionally unique in the field of crowdfunding. The prior crowdfunding processes do not have agreements that automatically remain in force after the funds are raised. Traditional crowdfunding operations require a back-and-forth between the company seeking funds, the platform, and the investors.

The platform host, or an entity affiliated with, or otherwise related to the platform host, manages any purchases of well-bore only working interest or other working interest from an oil and gas operator as a single working interest block. It is important to note that the purchase price of a well to be drilled covers the investors to the point of completion of the well. Only at that time is a working interest conveyance made to the platform host to manage the working interest block for the investors. This protects the investors from cost overruns. Previously, this could not be accounted for in a crowdfunding finance model.

The use of a Purchase & Sale Agreement that is contingent on crowdfunding indemnifies the investors from having to make out-of-pocket expenses down the road in order to maintain the oil and gas well. Typically, working interest owners must periodically make out-of-pocket payments to maintain production. However, that model is not practical for a crowdfunding application where numerous investors would have to be contacted after a well is drilled and asked to make additional payments. By indemnifying the purchaser for making future out-of-pocket expenses, except in the case of a re-working where the expenses have non-consent penalties, the present invention is novel in that it has specialized crowdfunding techniques in an investment model that has historically been utilized only by industry insiders. Whereas in a typical working interest investment, an investor can be subject to “capital calls” in which the working interest partner operating the well calls for capital from the other investors to pay for various expenses related to ongoing drilling operations (or the improvement or shutting down of drilling operations), the process of the present invention requires the operator to account for all contingencies and will avoid any capital calls. This is assured through the use of the unique Purchase & Sale Agreement. This creates more certainty for the operators in that they receive enough money to cover all contingencies without the risk of having to rely on the willingness of investors to put more capital into the operation. It also creates more certainty for the investors because they know exactly how much they must put into the operation and can more reliably calculate returns and risks.

The present invention is particularly unique because it addresses the problem of lack of transparency in oil and gas transactions. It creates an online exchange of due diligence materials where the operator seeking funding for a well uploads due diligence materials requested on a checklist or other list specifying the materials requested. The platform host then has backroom access to check off whether the digital diligence materials have been uploaded such that properly clear title to the well(s) is demonstrated and such material clearly shows ownership to a passive oil and gas interest that is sought to be offered to investors. As such, the present invention actually carries out online due diligence and vetting that can be expedited to manage the due diligence of the numerous transactions. Typically, a listing service does not actually perform due diligence itself but rather just posts the due diligence to potential buyers. Additionally, due diligence communications may be tracked online by the use of an internal messaging system in which all messages are tracked and stored in order to expedite the due diligence process. All due diligence is posted online on the platform to investors that anticipate participating in a transaction.

The present invention is also unique in the field of existing oil and gas financing methods by providing a crowdfunding model. The uses of the Purchase & Sale Agreement in the ways detailed herein is an entirely unique concept that has the ability to lock a drilling re-work, well stimulation, royalty or acquisition deal into place pending the raising of funds within a specific time frame. Without this feature, it would be extremely difficult to crowdfund such a deal because there would be no time in which the crowdfunding platform would have exclusive rights to raise funds and becomes locked into, and obligated to consumate, a deal immediately after the funds are raised. As such, the present invention creates a seamless integration of the fund-raising process into the field of hydrocarbon or energy ventures or projects.

Another unique feature the present invention is the building of the option into the Purchase & Sale Agreement for operators to simply check a box to determine what level of protection they want to offer investors as they compete for investor dollars for their project. The terms of the Purchase & Sale Agreement to be signed with the operator carefully balances the protection needs of the investor with the funding needs of the operator.

The present invention offers a pre-packaged option that expedites the ability to close a deal by minimizing the negotiation processes and keeps investors informed as to the various options that are chosen.

In the present invention, the investor funds that are deposited go directly into an escrow account where the third-party trustee at a major banking institution can only release the funds when the term of the Purchase & Sale Agreement contingent on crowdfunding require the funds to be released. This is a major innovation in that it provides the necessary investor protection in an industry having a history of shady operators that take advantage of the lack of investment opportunities.

When a well or wells become marginal and it makes more economic sense to package these wells for sale rather than to continue to take payments over the remaining life of the well, the platform host, or an entity affiliated therewith, or otherwise related to the platform host, has the ability in its contract with investors to sell these wells on behalf of the investors. This is novel in that it allows for crowdfunding to be a more attractive method of funding wells from the investor side, yet it addresses the limitations of crowdfunding by allowing one decision-maker to make this judgment call as opposed to having it collectively determined by investors. The collective determination by investors would be a totally unwieldy process. The Purchase & Sale Agreement contingent on crowdfunding protects the operator from having overhead costs exponentially increased when interest are sold. The operator is protected by clauses that allow it to prevent the sale of managed working interests blocks in amounts less than what was originally purchased. The operator also has a preferential right to purchase, further protecting it and reducing risks associated by using crowdfunding.

The foregoing disclosure and description of the invention is illustrative and explanatory thereof. Various changes in the steps of the described process can be made within the scope of the appended claims without departing from the true spirit of the invention. The present invention should only be limited by the following claims and their legal equivalents.

We claim:

1. A process for funding an energy venture or project, the process comprising:
establishing an on-line web-based platform that is accessible by investors, said platform being controlled by a platform host, said platform host including entities contracted with or owned by or controlled by said platform host;
providing a project proposal to said platform host;
establishing a Purchase & Sale Agreement between an operator and said platform host;
providing details of said project on said platform, said details including a funding goal;
accessing said platform by said investors so as to allow said investors to invest in said project; and
funding said project when the investment by said investors reaches said funding goal.

2. The process of claim 1, further comprising:
conducting due diligence by said platform host on said project proposal prior to the step of establishing the Purchase & Sale Agreement.

3. The process of claim 2, the step of conducting due diligence comprising:
reviewing a background and a history of said operator;
reviewing said project proposal; and
reviewing titles associated with said project proposal.

4. The process of claim 1, the step of providing the project proposal comprising:
submitting the project proposal to said platform host through said platform.

5. The process of claim 1, further comprising:
conveying a working interest or ownership share in the energy venture or project to said platform host after the step of funding.

6. The process of claim 1, further comprising:
conveying revenue from the project to the investors relative to an amount of the investment by the investor in the project.

7. The process of claim 6, the step of conveying comprising:
conveying the revenue from said operator to said platform host based on said Purchase & Sale Agreement; and
conveying revenue from said platform host to the investors.

8. The process of claim 1, further comprising:
accrediting the investor prior to allowing the investor to invest in the project.

9. The process of claim 1, further comprising:
setting a period of time for reaching said funding goal.

10. The process of claim 8, further comprising:
returning the investment to the investor if said funding goal is not reached within said period of time.

11. The process of claim 1, said Purchase & Sale Agreement providing for termination if said funding goal is not reached and for when funding is to occur after said funding goal is reached, and for an assignment of a working interest or ownership share at a completion of the project.

12. A process for funding an energy venture or project, the process comprising:
providing a project proposal to a platform host, said platform host including entities contracted to said platform host and entities owned by said platform host and entities under control of said platform host;
reviewing said project proposal by said platform host to determine if said project proposal meets criteria set by said platform host;
placing said project proposal on an on-line web-based platform, said platform being accessible by potential investors;
accessing said platform by said potential investors so as to allow said potential investors to invest in the project of said project proposal; and
funding the project with the investment by the investors.

13. The process of claim 12, further comprising:
establishing a funding goal for the project, the step of funding occurring only if the funding goal is reached.

14. The process of claim 13, said funding goal including a time period for funding and including an amount of funding.

15. The process of claim 12, the step of reviewing comprising:
conducting due diligence by said platform host; and
developing a Purchase & Sale Agreement between said platform host and an operator associated with said project proposal.

16. The process of claim 12, further comprising:
conveying a working interest or ownership share in the project to said platform host after the step of funding.

17. The process of claim 12, further comprising:
conveying a revenue from the project to the investors relative to an amount invested by the investors.

18. The process of claim 17, the step of conveying comprising:
conveying the revenue from the project to said platform host; and
conveying revenue from said platform host to the investors.

19. The process of claim 12, further comprising:
accrediting the potential investor by said platform host so as to cause the potential investor to become the investor.

20. The process of claim 13, further comprising:
returning the investment to the investor if said funding goal is not reached.
